(19) United States
(12) Patent Application Publication
(10) Pub. No.: US 2007/0195278 A1
(43) Pub. Date: Aug. 23, 2007

(54) Multi-color illuminating device and projection type video display

(75) Inventors: Yoshihiro Yokote, Osaka (JP); Ryuhei Amano, Osaka (JP); Kazuhiro Arai, Osaka (JP); Yoshitaka Kurosaka, Kyoto (JP); Makoto Maeda, Osaka (JP); Takashi Ikeda, Osaka (JP); Haruhiko Murata, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi City (JP)

(21) Appl. No.: 11/511,215

(22) Filed: Aug. 29, 2006

(30) Foreign Application Priority Data
Aug. 31, 2005 (JP) 2005-252852
Aug. 8, 2006 (JP) 2006-216175

(51) Int. Cl. G03B 21/26

(52) U.S. Cl. 353/34

(57) ABSTRACT

The projection type video display includes three illuminating devices (51R-1, 51G, and 51B). Each illuminating device includes a taper type rod integrator and a cuboid shaped rod integrator. The illuminating device (51R-1) emits red light; the illuminating device (51G) emits green light; and the illuminating device (51B) emits blue light. The illuminating device (51R-1) has a Fresnel lens. The illuminating devices (51G and 51B) do not have a Fresnel lens.

### BACKGROUND OF THE INVENTION

1. Field of the Invention

The present invention relates to a multi-color illuminating device and a projection type video display.

2. Description of the Related Art

In a projector's light source, the higher a parallelism of light from a light source is, the higher light use efficiency in an optical system becomes, therefore it is of advantage to raise directivity of an LED (light-emitting diode). Therefore, LED directivity is improved using a molded lens, a photonic crystal, and the like (refer to Japanese Unexamined Patent Publication No. 2005-149943).

### SUMMARY OF THE INVENTION

In a known optical system, however, uniformly raising directivity of each color LED has been difficult. For example, as shown in FIG. 15A and FIG. 15B, a red LED has higher light intensity in a divergence angle coverage from −30° to −60° and in a divergence angle coverage from 30° to 60° than that of a green LED and a blue LED (for example, refer to Japanese Unexamined Patent Publication No. 2000-25326). The LEDs which are different in directivity are used as a light source and when lights in respective colors emitted from the light source are guided to a display panel by illumination systems having the same structure, there arises a difference in illuminance distribution (luminance bias within an illumination surface), divergence angle distribution (distribution state shown in FIG. 15A and FIG. 15B), and divergence angle distribution within surface (divergence angle distribution at each point within the illumination surface) in respective colors; and therefore color ununiformity is generated on the screen.

In view of the foregoing, an object of the present invention is to reduce generation of the difference in at least one of the illuminance distribution, the divergence angle distribution, and the divergence angle distribution within surface in each light in respective colors while solid light-emitting elements in which directivity is different in each illuminating device in respective colors are used and to prevent a projection type video display using the illuminating devices from generating color ununiformity.

In order to solve the foregoing problem, according to the present invention, there is provided a multi-color illuminating device, including a plurality of illuminating devices for a plurality of lights in different colors, each of the plurality of illuminating devices including a solid light-emitting element for emitting color light and a light guide member for guiding the color light from the solid light-emitting element to an object to be illuminated, wherein optical characteristics in one of the illuminating devices or in some of the illuminating devices differentiate from optical characteristics in other illuminating devices so that at least one of illuminance distribution, divergence angle distribution, and divergence angle distribution within surface in each light in respective colors guided to the object to be illuminated is approximated among each of the illuminating devices (referred to as a first configuration below in this section).

In the case of the aforementioned configuration, optical characteristics in one of the illuminating devices or in some of the illuminating devices differentiate from optical characteristics in other illuminating devices so that at least one of illuminance distribution, divergence angle distribution, and divergence angle distribution within surface in each light in respective colors guided to the object to be illuminated is approximated among each of the illuminating devices; and therefore, it is possible to reduce to make a difference in at least one of illuminance distribution, divergence angle distribution, and divergence angle distribution within surface in each light in respective colors, while using solid light-emitting elements in each of which directivity is different in each illuminating device in respective colors.

In the aforementioned first configuration, the illuminating device which is differentiated from the other illuminating devices may include a lens member disposed at any place between the solid light-emitting element and the object to be illuminated, for reducing a divergence angle of the light emitted from the solid light-emitting element (referred to as a second configuration below in this section). Furthermore, in the aforementioned configuration, the lens member is arranged apart from a light incident surface of the light guide member and a pipe-shaped mirror member which surrounds the circumference from the light incident surface to the arrangement position of the lens member may be provided (referred to as a third configuration below in this section).

In the multi-color illuminating device of any of the aforementioned first configuration to third configuration, each of the illuminating devices may include a taper type rod integrator in which a light emission surface is larger than a light incident surface as the light guide member; and the rod integrator of the illuminating device which is differentiated from the other illuminating devices may have a larger taper angle than that of the rod integrators of the other illuminating devices. Alternatively, each of the illuminating devices may include a taper type rod integrator in which a light emission surface is larger than a light incident surface as the light guide member; and the rod integrator of the illuminating device which is differentiated from the other illuminating devices may have the same light incident surface and light emission surface as those of the rod integrator of the other illuminating devices, and at the same time may be longer in length than that of the rod integrator of the other illuminating devices.

In the multi-color illuminating device of any of the aforementioned first configuration to third configuration, each of the illuminating devices may include a taper type rod integrator in which a light emission surface is larger than a light incident surface as the light guide member; and the rod integrator of the illuminating device which is differentiated from the other illuminating devices may have a curved surface reflecting region which is more convex than an inclined reflecting surface in other taper type rod integrator. In such a configuration, a cuboid shaped rod integrator may be provided on a light emission surface side of the each taper type rod integrator.

In the multi-color illuminating device of any of the aforementioned first configuration to third configuration, the light guide member of the illuminating device which is differentiated from the other illuminating devices may have a lens-shaped portion serves as a light condensing function or may have a lens-shaped portion whose curvature is different from that of a lens-shaped portion which other light guide member has. In such a configuration, each light guide member may include a taper type rod integrator in which a light emission surface is larger than a light incident surface and a cuboid shaped rod integrator provided on a light emission surface side of the taper type rod integrator and the lens-shaped portion may be formed on a light incident end or a light emission end of the cuboid shaped rod integrator, or on a light emission end of the taper type rod integrator.

In the multi-color illuminating device of any of the aforementioned first configuration to third configuration, each of the illuminating devices may include a rod integrator made of a transparent body as the light guide member; and the illuminating device which is differentiated from the other illuminating devices has a rod integrator with a refraction index which is smaller than that of a rod integrator of the other illuminating device. In such a configuration, each rod integrator may be a taper type rod integrator in which a light emission surface is larger than a light incident surface and a cuboid shaped rod integrator may be provided on a light emission surface side of the taper type rod integrator.

In the multi-color illuminating device of any of the aforementioned first configuration to third configuration, each of the illuminating devices may include a taper type rod integrator in which a light emission surface is larger than a light incident surface and a cuboid shaped rod integrator provided on a light emission side of the taper type rod integrator as the light guide member; and length of the cuboid shaped rod integrator of the illuminating device which is differentiated from the other illuminating devices is different from that of the cuboid shaped rod integrator of the other illuminating devices.

In the above described multi-color illuminating device which is of the configuration having the cuboid shaped rod integrator, length of the cuboid shaped rod integrator in the illuminating device which is differentiated from the other illuminating devices may be different from that of the cuboid shaped rod integrator in the other illuminating devices.

In these configured multi-color illuminating devices, an illuminating device for a red color, an illuminating device for a green color, and an illuminating device for a blue color may be included (referred to as a first three color configuration below in this section). In such a configuration, optical characteristics in the illuminating device for a red color may be different from that of the illuminating device for a green color and the illuminating device for a blue color.

Furthermore, according to the present invention, there is provided a multi-color illuminating device, including solid light-emitting elements for emitting color lights; an optical element for guiding color lights from the each solid light-emitting element to a specified direction depending on wavelength; and a taper type rod integrator as a light guide member for guiding the light emitted from the optical element to an object to be illuminated, wherein the taper type rod integrator is formed with a tapered pipe-shaped surface functioning as a dichroic mirror surface with respect to a specified color light; and the tapered pipe-shaped surface has an inlet port which is formed smaller than a light incident surface of the taper type rod integrator, whereby divergence angle distribution in each light in respective colors guided to the object to be illuminated is approximated among each light in respective colors (referred to as a fourth configuration below in this section). In the aforementioned fourth configuration, a cuboid shaped rod integrator may be provided on a light emission surface side of the taper type rod integrator. Furthermore, in this configuration, an extended tapered pipe-shaped surface which is an extended area of the tapered pipe-shaped surface may be formed in the cuboid shaped rod integrator. Further, in these configurations, a solid light-emitting element for a red color, a solid light-emitting element for a green color, and a solid light-emitting element for a blue color may be provided (referred to as a second three color configuration below in this section). In the aforementioned second three color configuration, the aforementioned tapered pipe-shaped surface may be configured such that red light is reflected and other color light is transmissive.

Furthermore, according to the present invention, there is provided a multi-color illuminating device, including solid light-emitting elements for emitting color lights; an optical element for guiding color lights from the each solid light-emitting element to a specified direction depending on wavelength; and a light guide member for guiding the light emitted from the optical element to an object to be illuminated, the multi-color illuminating device including: a diffractive element having wavelength-selectivity disposed at any place between the solid light-emitting element and the object to be illuminated, for reducing a divergence angle with respect to a specified color light so that divergence angle distribution in each light in respective colors guided to the object to be illuminated is approximated among each light in respective colors (referred to as a fifth configuration below in this section). In the fifth configuration, a cuboid shaped rod integrator may be provided on a light emission surface side of the taper type rod integrator. In these configurations, a solid light-emitting element for a red color, a solid light-emitting element for a green color, and a solid light-emitting element for a blue color may be provided (referred to as a third three color configuration below in this section). In the third three color configuration, the aforementioned diffractive element may reduce a divergence angle in red light.

Further, according to the present invention, there is provided a projection type video display, including a multi-color illuminating device with the first three color configuration or a configuration depending from the first three color configuration, the projection type video display including: light valves for modulating each light in respective colors; an optical element for generating full color image light by guiding to a specified direction each modulated light passed through the each light valve; and a projecting device for projecting the full color image light.

Further, according to the present invention, there is provided a projection type video display, including a multi-color illuminating device with the second three color configuration or the third three color configuration, or a configuration depending from these configurations, the projection type video display including: a single light valve provided on a light emission side of the light guide member; and a projecting device for projecting color image light obtained by the single light valve. In such a configuration, the each light in respective colors may be emitted in time-sharing manner; and the light valve may be driven by each video signal in respective colors depending on the time-shared timing. Alternatively, the each light in respective colors may be continuously emitted; and the light valve may include a color filter.

According to the present invention, there is an effect that can reduce generation of the difference in the illuminance distribution, the divergence angle distribution, and the divergence angle distribution within surface in each light in respective colors while solid light-emitting elements in which directivity is different in each illuminating device in respective colors are used and prevent a projection type video display using the illuminating devices from generating color ununiformity.

The above and other objects, features, modes, and advantages of the present invention will become clear from the following detailed description with reference to the attached drawings.

### BRIEF DESCRIPTION OF THE DRAWINGS

FIG. 1A is an explanation view showing an optical system of a multi-color illuminating device and a projection type video display according to an embodiment of the present invention, and FIG. 1B is an explanation view showing a modified example of an illuminating device for a red color;

FIG. 2A is a view showing a part of an illuminating device for a green color and an illuminating device for a blue color with which a Fresnel lens in the multi-color illuminating device shown in FIG. 1 is not provided, FIG. 2B is a view showing function of the aforementioned Fresnel lens, and FIG. 2C is an enlarged view of an illuminating device for a red color;

FIG. 3A is a view showing a multi-color illuminating device according to other embodiment of the present invention and an explanation view showing an illuminating device for a red color, and FIG. 3B is an explanation view showing an illuminating device for a green color and an illuminating device for a blue color;

FIG. 4A is an explanation view showing an optical system of a multi-color illuminating device and a projection type video display according to other embodiment of the present invention, and FIG. 4B is an enlarged view of a part of an illuminating device for a red color;

FIG. 5A is an explanation view showing an optical system of a multi-color illuminating device and a projection type video display according to other embodiment of the present invention, FIG. 5B is an enlarged view showing a part of an illuminating device for a red color, FIG. 5C is an explanation view showing a modified example of an illuminating device for a red color and, FIG. 5D is an explanation view showing a modified example of an illuminating device for a red color;

FIG. 6A is a view showing a multi-color illuminating device according to other embodiment of the present invention and an explanation view of an illuminating device for a green color and an illuminating device for a blue color, and FIG. 6B is an explanation view showing an illuminating device for a red color;

FIG. 7A and FIG. 7B are explanation views for explaining difference of refracting angle due to difference in refraction index;

FIG. 8A is a view showing a multi-color illuminating device according to other embodiment of the present invention and an explanation view showing an illuminating device for a red color, FIG. 8B and FIG. 8C are explanation views showing an illuminating device for a green color and an illuminating device for a blue color, and FIG. 8D is an explanation view showing a modified example of an illuminating device for a red color;

FIG. 9 is an explanation view showing a multi-color illuminating device and a projection type video display according to other embodiment of the present invention;

FIG. 10 is an explanation view showing a rod integrator of the multi-color illuminating device in the projection type video display shown in FIG. 9;

FIG. 11 is an explanation view showing a modified example of the projection type video display shown in FIG. 9;

FIG. 12 is an explanation view showing a multi-color illuminating device and a projection type video display according to other embodiment of the present invention;

FIG. 13A and FIG. 13B are views showing other embodiment of the present invention and explanation views showing an application example of a polarization conversion device;

FIG. 14 is a graph showing transmittance characteristics of an optical filter; and

FIG. 15A is a graph showing divergence angle distribution of a red LED, and FIG. 15B is a graph showing divergence angle distribution of a green LED and a blue LED.

### DESCRIPTION OF THE PREFERRED EMBODIMENTS

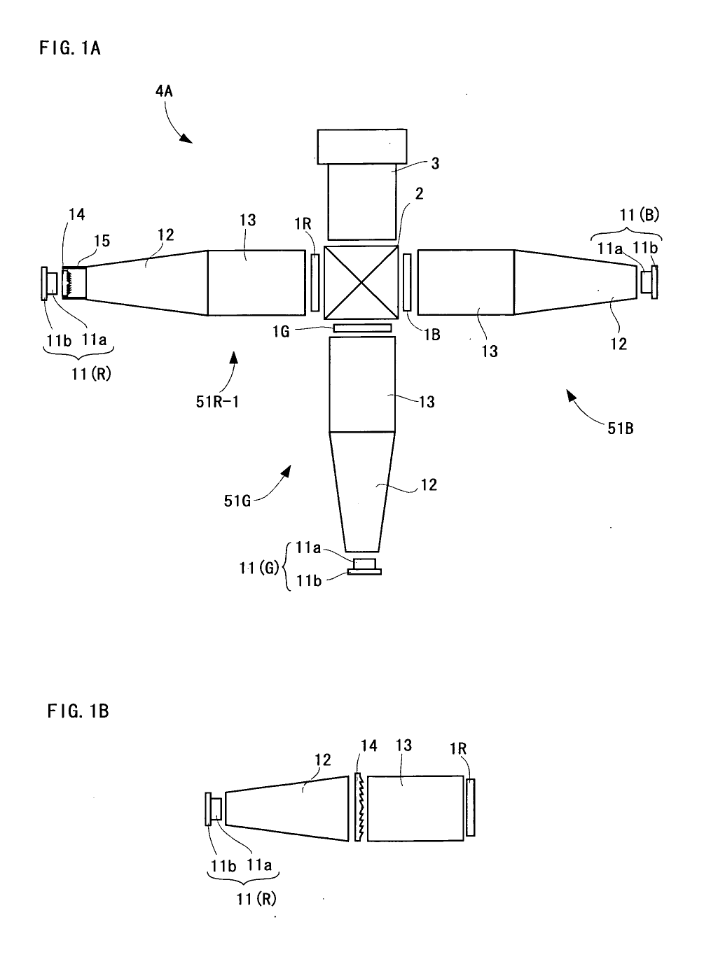

Embodiments according to the present invention will be described below on the basis of FIG. 1 to FIG. 14. It should be noted that, the following embodiments are exemplified in view of that it is difficult to keep light extraction efficiency of an LED while increasing directivity thereof due to difference in materials (red: AlInGaP group, blue and green: InGaN group) in a red LED, a blue LED, and a green LED (that is, an illuminating device which is differentiated from other illuminating devices is an illuminating device for red light). As a matter of course, it is likely that the increase in directivity is difficult as compared with other color light in color light other than red color light and therefore an illuminating device emitting color light other than such red light can be set as an illuminating device which is differentiated from other illuminating devices.

### Embodiment 1

FIG. 1A is a view showing an optical system of a projection type video display 4A. The projection type video display 4A includes three illuminating devices 51R-1, 51G, and 51B. Each illuminating device 51 includes an LED (light-emitting diode) 11, a taper type rod integrator 12, and a cuboid shaped rod integrator 13.

The LED 11 is composed of an LED chip 11a and a heat sink 11b. The LED chip 11a in the illuminating device 51R-1 emits red light, the LED chip 11a in the illuminating device 51G emits green light, and the LED chip 11a in the illuminating device 51B emits blue light.

Each light in respective colors emitted from each illuminating device 51 passes through liquid crystal display panels 1R, 1G, and 1B for respective colors, thereby forming each color image light. Then, respective color image lights are combined by a cross dichroic prism 2 (a cross dichroic mirror may be used) to form full color image light. The full color image light is projected by a projection lens 3.

In this case, the illuminating device 51R-1 has a pipe-shaped member (mirror pieced rod) 15 whose internal face is a mirror surface and a Fresnel lens 14 on a light incident side of the taper type rod integrator 12. The pipe-shaped member 15 is present in a range from the circumference of the Fresnel lens 14 to the light incident side of the taper type rod integrator 12. The illuminating device 51G and 51B do not include the Fresnel lens 14 and the pipe-shaped member 15.

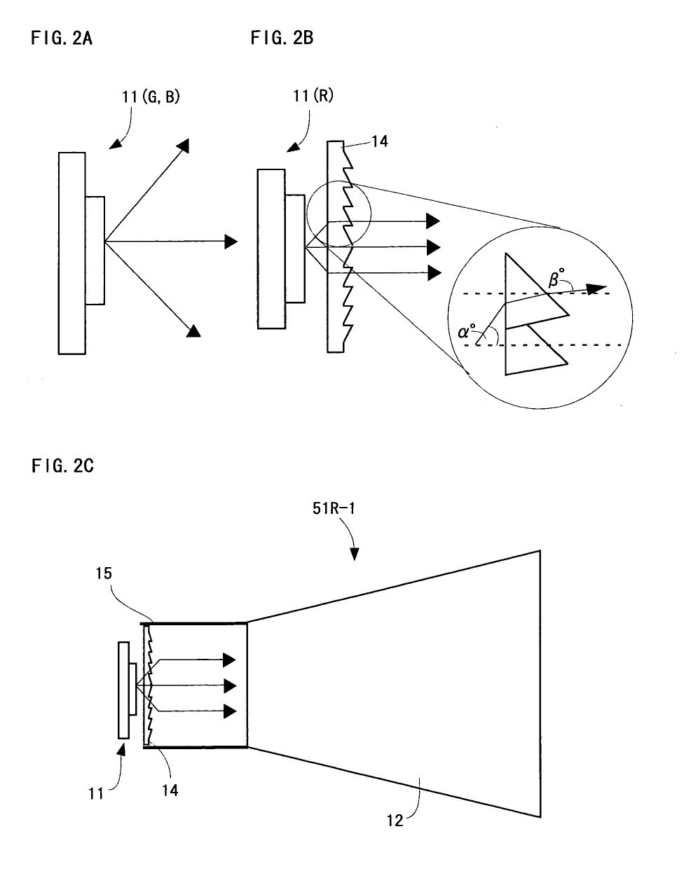

FIG. 2C is an enlarged view of the illuminating device 51R-1 (the rod integrator 13 is omitted). Furthermore, FIG. 2A shows a state of spread (divergence) of light in the LED (green light LED 11 and blue light LED 11) when the Fresnel lens is not provided; and FIG. 2B shows a state of reduction of a light divergence angle in the LED (red light LED 11) when the Fresnel lens 14 is provided. Light emitted at a large divergence angle (αa°) passes through the Fresnel lens 14, thereby being converted to a small divergence angle (β°). As a matter of course, since light incident on a surface except for an effective surface of the Fresnel lens 14 cannot be effectively used, there is a possibility of decreasing light use efficiency; however, directivity of an effective component in the light incident on the taper type rod integrator 12 is substantially uniform with the other wavelength ranges (green and blue) and therefore reduction in color ununiformity is possible. Furthermore, as shown in the drawing, the Fresnel lens 14 may be surrounded by the aforementioned pipe-shaped member 15; and in this case, light availability can be increased. Further, an circle zone of the Fresnel lens 14 may be formed in ellipse shape in accordance with the shape of the LED 11. Still further, it is not limited to the Fresnel lens 14, but a meniscus lens and the like which can reduce the divergence angle may be used.

It should be noted that, a configuration in which the cuboid shaped rod integrator 13 is omitted may be used. The taper type rod integrator 12 and the cuboid shaped rod integrator 13 are not limited to those made of a transparent body such as glass, but those having a hollow construction whose internal face is a mirror surface may be used. The pipe-shaped member 15 may be omitted by closely disposing the Fresnel lens 14 to the light incident surface of the taper type rod integrator 12. Furthermore, as shown in FIG. 1B, the Fresnel lens 14 may be present at a midstream location of the rod integrator. Further, the Fresnel lens 14 may be present at the light incident side of the liquid crystal display panel.

### Embodiment 2

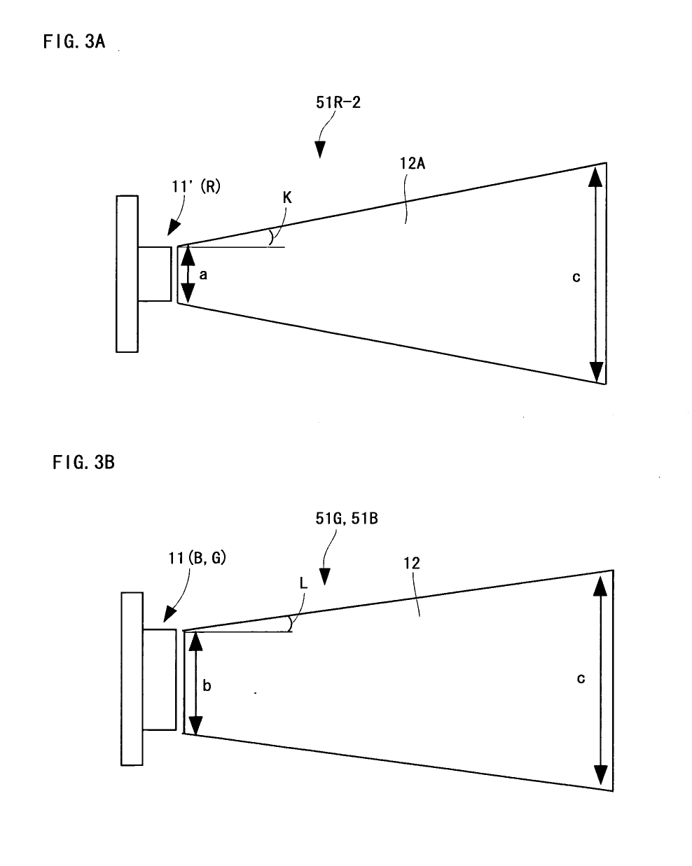

FIG. 3A is an enlarged view showing a part of an illuminating device 51R-2 (a rod integrator 13 is omitted); and FIG. 3B is an enlarged view showing a part of an illuminating device 51R or 51G (the rod integrator 13 is omitted). The whole configuration as a projection type video display is the same as the projection type video display 4A. A shape of a light emission surface of the taper type rod integrator 12 is, for example, the same or the substantially the same as an aspect ratio of the liquid crystal display panel 1 (a horizontal width is denoted by c in the drawing). A shape of the light incident surface of a taper type rod integrator 12A is also, for example, the same or the substantially the same as the aspect ratio of the liquid crystal display panel 1.

In this case, when a horizontal width of the light incident surface of the taper type rod integrator 12 in the illuminating devices 51G or 51B is denoted by b and a horizontal width of the light incident surface of the taper type rod integrator 12A in the illuminating device 51R-2 is denoted by a, it is such that a relationship of a<b is realized. A length of each taper type rod integrator is the same. Then, a luminous area of an LED 11′(R) for red light is smaller than that of the LEDs 11 for other color lights. A ratio of an emission end area and an incident end area in the taper type rod integrator 12A with respect to a red light source is larger than that of an emission end area and an incident end area in the taper type rod integrator 12 with respect to a green light source or the like and therefore conversion from light with a large divergence angle to light with a small divergence angle is promoted. Thereby, a light divergence angle distribution of the light emitted from the taper rod is substantially the same as those of other wavelength ranges (green and blue) and therefore it is possible to reduce color ununiformity. It should be noted that, a configuration in which the cuboid shaped rod integrator 13 is omitted can be used. The taper type rod integrators 12 and 12A and the cuboid shaped rod integrator 13 are not limited to those made of a transparent body such as glass, but those having a hollow construction whose internal face is a mirror surface may be used. It should be noted that, when configurations shown in FIG. 3A and FIG. 3B are represented by other representation, a taper angle (K) of the taper type rod integrator of the illuminating device which is differentiated from other illuminating devices is larger than a taper angle (L) of the taper type rod integrator of the other illuminating devices.

### Embodiment 3

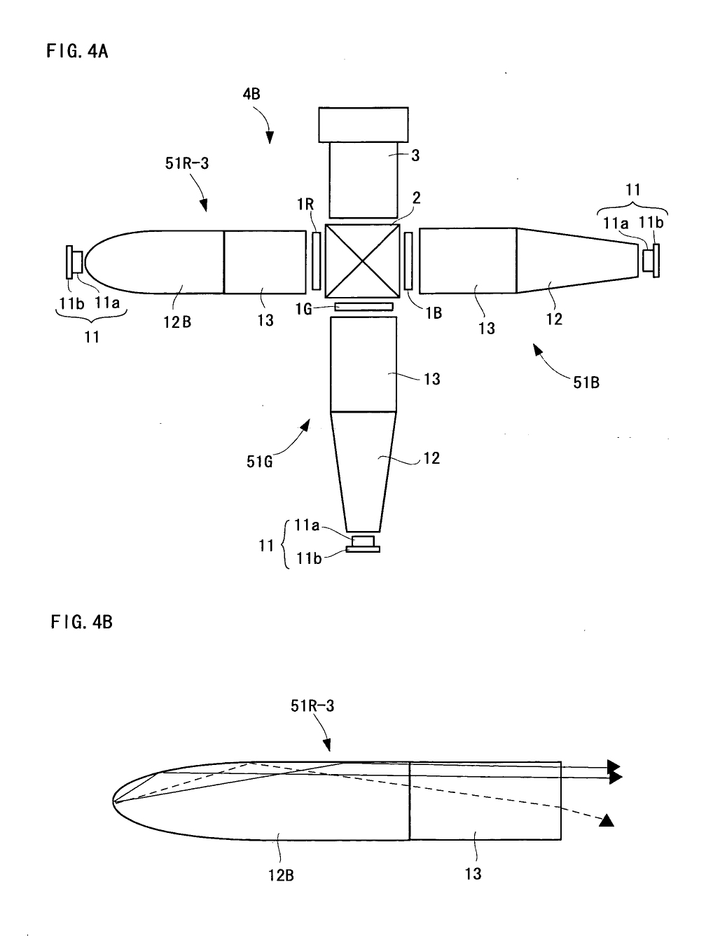

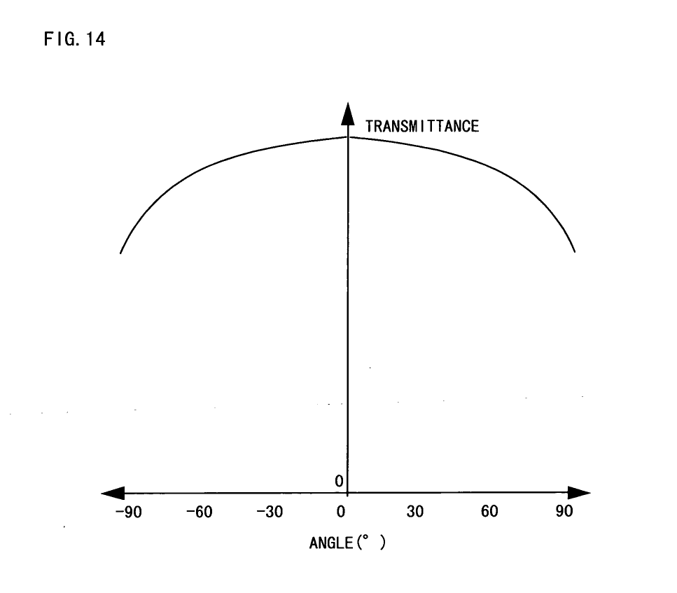

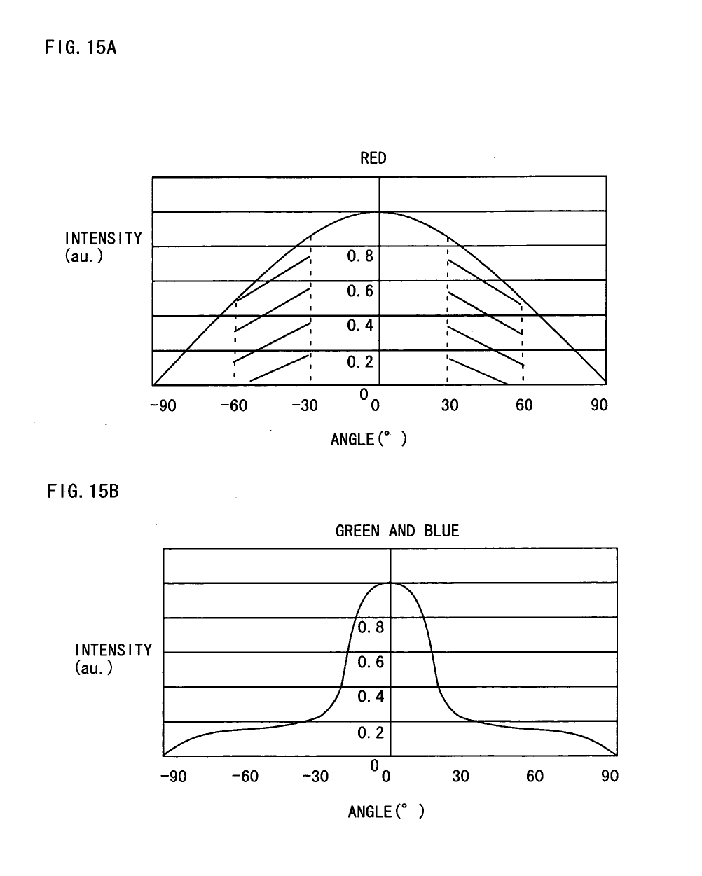

FIG. 4A is an explanation view showing a projection type video display 4B. A configuration as the whole of the projection type video display 4B is the same as the projection type video display 4A. FIG. 4B is an explanation view showing an illuminating device 51R-3 and effect of reducing a divergence angle caused by a curved surface. A taper type rod integrator 12B in the illuminating device 51R-3 has a curved surface reflecting region which is more convex than an inclined reflecting surface in other taper type rod integrators 12. The nearer the tangential line of the curved surface in the curved surface reflecting region places to a light incident surface, the larger the angle with respect to an optical axis of the taper type rod integrator 12B becomes; whereas the farther the tangential line places from the light incident surface, the smaller the angle with respect to the optical axis becomes. Thereby, the rod integrator 12B receives light in a divergence angle coverage of −30° to −60° and in a divergence angle coverage of 30° to 60° shown in FIG. 14A at a curved surface nearer to the side of the aforementioned light incident surface and converts the light to light oriented in parallel to the optical axis as much as possible. It is possible to reduce the divergence angle with respect to a large divergence angle component of light emitted from LED by the taper type rod integrator 12B with such a curved reflecting region and consequently small divergence angle distribution equivalent to that of other wavelength ranges (green and blue) can be obtained. Thereby, divergence angle distribution of effective component of the emitted light from the taper rod is substantially uniform with that of other wavelength ranges (green and blue) and therefore it is possible to reduce color ununiformity. It should be noted that, a configuration in which the cuboid shaped rod integrator 13 is omitted can be adopted. The taper type rod integrators 12 and 12B and the cuboid shaped rod integrator 13 are not limited to those made of a transparent body such as glass, but those having a hollow construction whose internal face is a mirror surface may be used.

### Embodiment 4

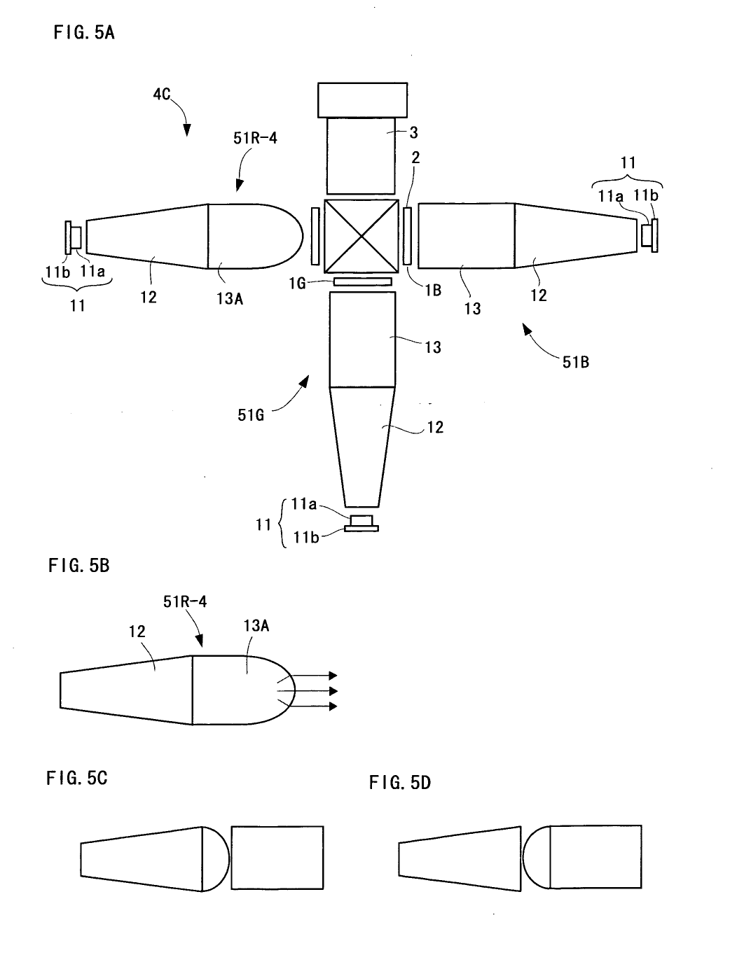

FIG. 5A is an explanation view showing a projection type video display 4C. Configuration as the whole of the projection type video display 4C is the same as the projection type video display 4A. FIG. 5B is an explanation view showing an illuminating device 51R-4 and effect of reducing a divergence angle caused by a lens. A light emission end of a cuboid shaped rod integrator 13A in the illuminating device 51R-4 has a shape of a convex lens. Light with a large divergence angle at the light emission end of the rod integrator is converted to light with a small divergence angle by the shape of the convex lens and therefore divergence angle distribution of effective component of an emitted light from the taper rod is substantially uniform with that of other wavelength ranges (green and blue) and therefore reduction in color ununiformity is possible. It should be noted that, the cuboid shaped rod integrator 13A may be omitted and a light emission surface of the taper type rod integrator 12 may be formed with a lens shape serving as a light condensing function. In addition, as shown in FIG. 5C, the lens shape may be formed on a light emission surface of the taper type rod integrator and a cuboid shaped rod integrator may be provided on the light emission side of the taper type rod integrator. Furthermore, as shown in FIG. 5D, the lens shape may be formed on a light incident side of the cuboid shaped rod integrator. Still further, the rod integrators except for red light, also, may have the lens shape may be included in. Then, for example, curvature of the lens shape with respect to red light is smaller than that of lens shape with respect to other color lights, thereby converting the light with a large divergence angle to light with a small divergence angle at the emission end of the rod integrator. Thereby, divergence angle distribution of effective component of the emitted light from the rod integrator is substantially uniform with that of other wavelength ranges (green and blue) and therefore it is possible to reduce color ununiformity. Furthermore, the lens shape is not limited to the convex lens, but a shape of a Fresnel lens or the like may be used. It should be noted that, the taper type rod integrator 12 is not limited to those made of a transparent body such as glass, but those having a hollow construction whose internal face is a mirror surface may be used.

### Embodiment 5

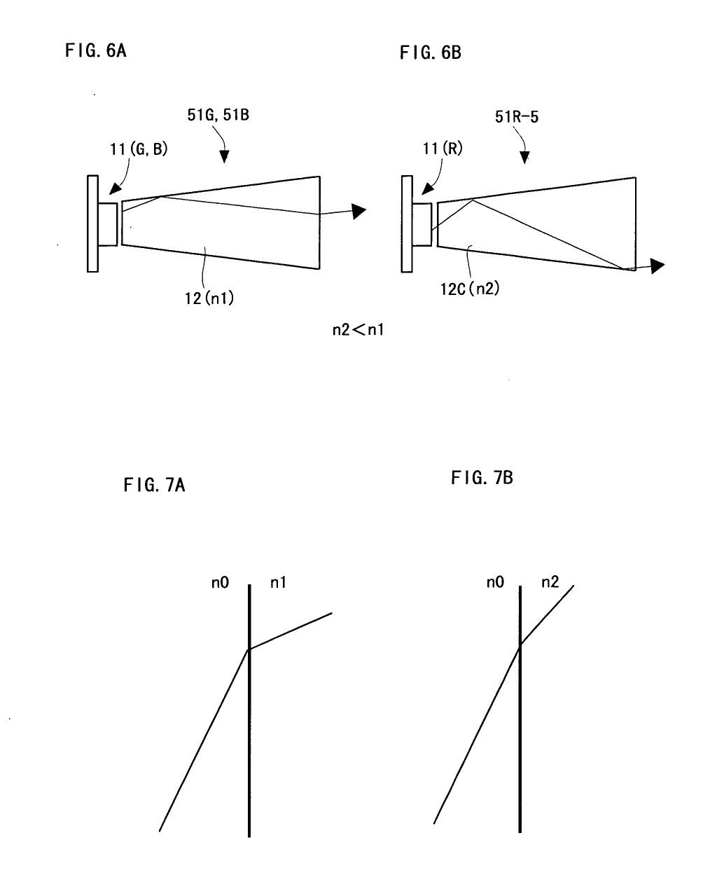

FIG. 6A is an enlarged view (a rod integrator 13 is omitted) showing a part of illuminating devices 51B and 51G; and FIG. 6B is an enlarged view (the rod integrator 13 is omitted) showing a part of an illuminating device 51R-5. The whole configuration as a projection type video display is the same as the projection type video display 4A. In this embodiment, the illuminating device 51R-5 which emits light (red light) of wavelength range different from other light in directivity includes a taper type rod integrator 12C using glass made of low refraction index medium. When a refraction index of the taper type rod integrator 12 is nil and a refraction index of the taper type rod integrator 12C is n2, n2<n1 is realized. FIG. 7A and FIG. 7B diagrammatically show an effect caused by including the low refraction index medium (where, n0<n2<n1). As shown in FIG. 7A and FIG. 7B, light incident on the low refraction index medium is smaller in refracting angle than light incident on a high refraction index medium. Accordingly, the number of reflections of light with a large divergence angle in the taper type rod integrator 12C can be increased and therefore conversion from light with a large divergence angle to light with a small divergence angle is promoted. Thereby, divergence angle distribution of effective component of the emitted light from the taper rod is substantially uniform with that of other wavelength ranges (green and blue) and therefore it is possible to reduce color ununiformity. It should be noted that, a configuration in which the cuboid shaped rod integrator 13 is omitted can be adopted. In addition, the cuboid shaped rod integrator 13 is not limited to those made of a transparent body such as glass, but those having a hollow construction whose internal face is a mirror surface may be used.

### Embodiment 6

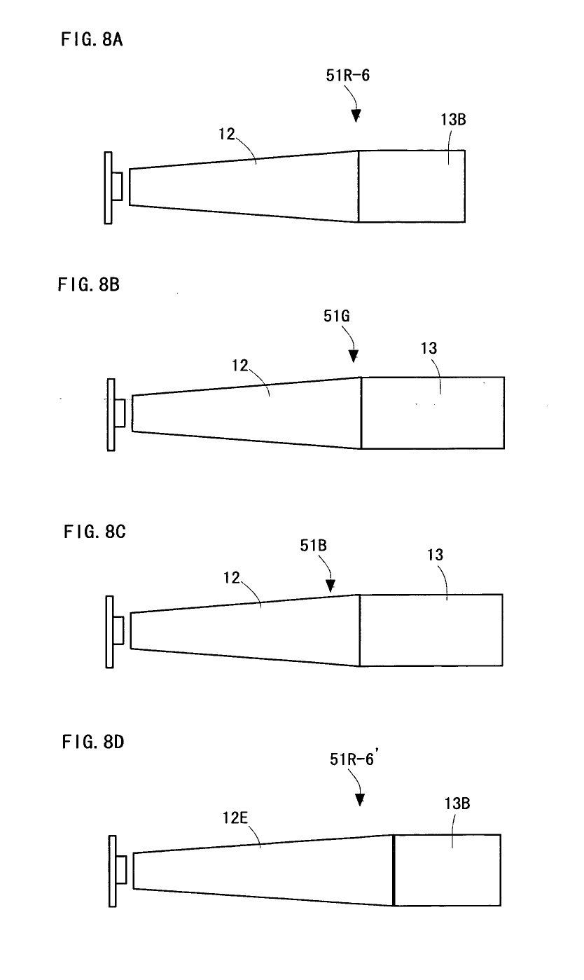

FIG. 8A is an enlarged view showing an illuminating device 51R-6;

FIG. 8B is an enlarged view showing an illuminating device 51G; and FIG. 8C is an enlarged view showing an illuminating device 51B. The whole configuration as a projection type video display is the same as the projection type video display 4A. In this embodiment, a cuboid shaped rod integrator 13B in the illuminating device 51R-6 in which light (red light) of wavelength range different from other light in directivity is emitted from an LED is shorter than the cuboid shaped rod integrator 13 in other illuminating devices. As described, the illuminating device 51R-6 obtains illuminance distribution and divergence angle distribution within surface equivalent to other wavelength ranges (green and blue) by the cuboid shaped rod integrator 13B. It should be noted that, in the configuration using the cuboid shaped rod integrator 13 whose length is different (short or long) from other one as described, it may be further configured as follows: the Fresnel lens 14 is used as shown in Embodiment 1; the taper type rod integrator 12A is used as shown in Embodiment 2; the taper type rod integrator 12B is used as shown in Embodiment 3; and the lens shape is formed on the light emission end of the cuboid shaped rod integrator 13A as shown in Embodiment 4. In such cases, the divergence angle distribution can be further adjusted equally to other wavelength ranges (green and blue). It should be noted that, in place of the illuminating device 51R-6 shown in FIG. 8A, an illuminating device 51R-6′ shown in FIG. 8D may be used. The illuminating device 51R-6′ has a taper type rod integrator 12E which is longer than the taper type rod integrator 12 in the illuminating device 51G and the illuminating device 51B. Each the shape and size of the light incident surface in these rod integrators is the same, and each the shape and size of the light emission surface in these rod integrators is the same. The number of reflections of light with a large divergence angle in the taper type rod integrator 12E which is long in whole length increases and therefore conversion from light with a large divergence angle to light with a small divergence angle is promoted.

### Embodiment 7

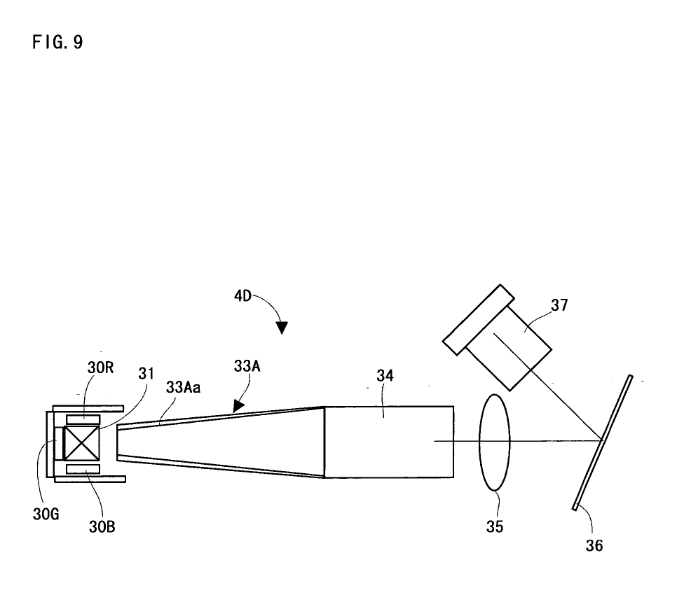

FIG. 9 is a view showing an optical system of a projection type video display 4D. The projection type video display 4D includes a cross dichroic prism 31 which guides color lights from LEDs 30R, 30G, and 30B, each emitting each light in respective colors, to a specified direction depending on the wavelength. In place of the cross dichroic prism 31, a cross dichroic mirror may be used, or an optical element that guides each light in respective colors in the specified direction by a structure other than those parts. A taper type rod integrator 33A is arranged on a light emission side of the cross dichroic prism 31. Furthermore, a cuboid shaped rod integrator 34 is arranged on a light emission side of the taper type rod integrator 33A. Light emitted from the cuboid shaped rod integrator 34 is guided to a reflective type display panel 36 by a lens 35. Image light obtained by reflecting on the display panel 36 is projected by a projection lens 37.

The projection type video display 4D of such a configuration emits each light in respective colors (red light, green light, and blue light) in time-sharing manner and drives the aforementioned display panel 36 by each video signal in respective colors depending on the aforementioned time-shared timing. Alternatively, each light in respective colors (red light, green light, and blue light) is continuously emitted, and a display panel including a color filter as the display panel 36 may be used. As a matter of course, a transmissive type display panel may be used in place of the reflective type display panel 36.

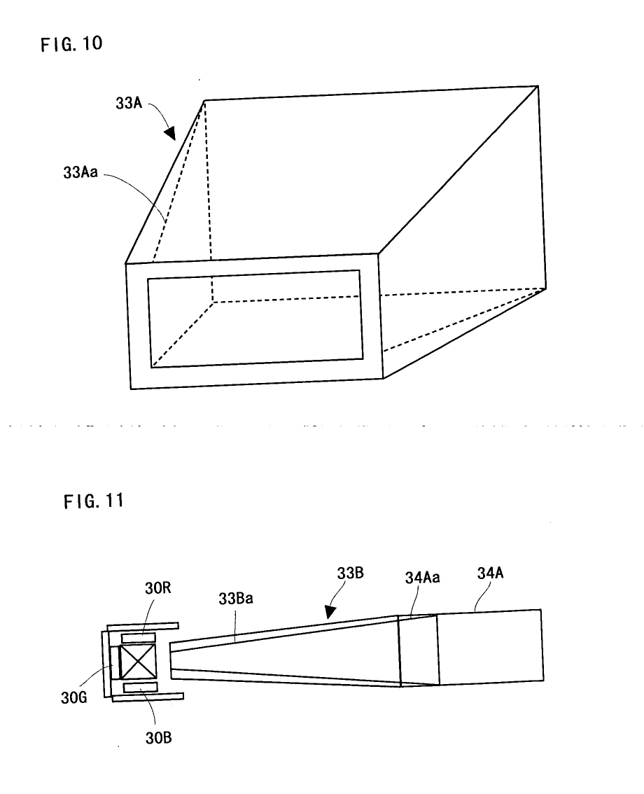

The taper type rod integrator 33A has a tapered pipe-shaped surface 33Aa functioning as a dichroic mirror surface with respect to red light, as shown in FIG. 10. An inlet port of the tapered pipe-shaped surface 33Aa is formed to be smaller than the light incident surface of the taper type rod integrator 33A; and an inclined surface (red light reflecting surface) of the tapered pipe-shaped surface 33Aa is steeper than that (other color light reflecting surface) of the taper type rod integrator 33A. Thereby, effect which is the same as one using the taper rod in which only red light is small in the incident end area (the inclined surface is steep) can be obtained and therefore reducing of a divergence angle is promoted than that of other wavelength ranges (green and blue); divergence angle distribution of effective component of the emitted light from the taper rod is substantially uniform with that of other wavelength ranges (green and blue); and color ununiformity can be reduced.

The taper type rod integrator 33A can be obtained by, for example, a dichroic film (dielectric multi-layered film) in which red light reflects and other color lights are transmissive forming on the circumference surface of a glass body having a trapezoidal shape in section, and inserting in a rectangular tube glass body having a hollow portion corresponding to the glass body. Alternatively, the taper type rod integrator 33A can be also a hollow member in which the dichroic film (dielectric multi-layered film) is formed in the internal surface of the rectangular tube glass body having the aforementioned hollow portion.

FIG. 11 is an explanation view showing a taper type rod integrator 33B and a cuboid shaped rod integrator 34A. The taper type rod integrator 33B has a tapered pipe-shaped surface 33Ba functioning as a dichroic mirror surface with respect to red light. An inlet port of the tapered pipe-shaped surface 33Ba is formed to be smaller than the light incident surface of the taper type rod integrator 33B. Then, a tapered pipe-shaped surface 34Aa is formed in the cuboid shaped rod integrator 34A in a form of extending the aforementioned tapered pipe-shaped surface 33Ba.

### Embodiment 8

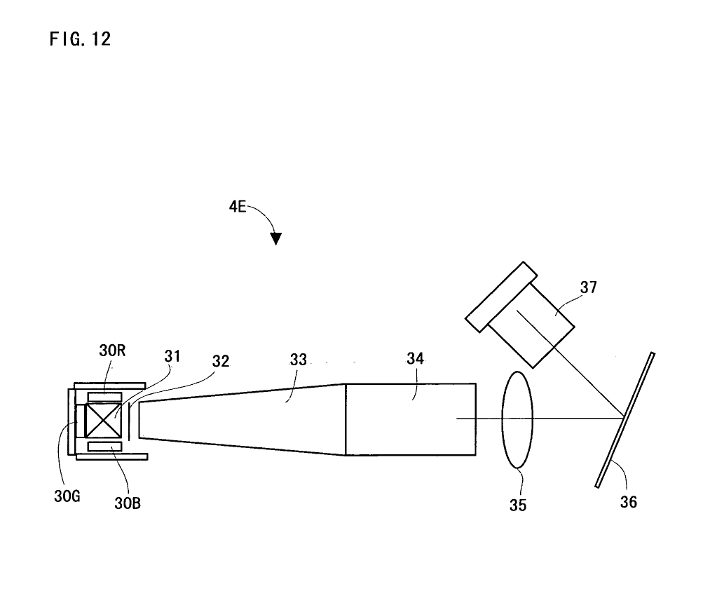

FIG. 12 is a view showing an optical system of a projection type video display 4E. The projection type video display 4E has the same configuration as the projection type video display 4D; however, the projection type video display 4E has a usual taper type rod integrator 33 and a diffractive element having wavelength-selectivity 32 which is provided between the light emission side of the cross dichroic prism 31 and the light incident surface of the taper type rod integrator 33 to produce of reducing a divergence angle with respect to red light. Divergence angle distribution of lights in respective colors are approximated each other by the diffractive element 32. That is, since the projection type video display 4E is provided with the diffractive element 32 which produces of reducing a divergence angle with respect to red light, only the divergence angle of red light is reduced. Therefore, divergence angle distribution of effective component of an emitted light from the taper rod is substantially uniform with that of other wavelength ranges (green and blue) and it is possible to reduce color ununiformity. It should be noted that, a cuboid shaped rod integrator may be used in place of the taper type rod integrator 33. No cuboid shaped rod integrator 34 may be configured. The taper type rod integrator 33 and the cuboid shaped rod integrator 34 are not transparent bodies such as glass; however, those having a hollow construction may be used. It should be noted that, one disclosed in Japanese Unexamined Patent Publication No. 2002-350625 is known as a diffractive element having wavelength-selectivity. It should be noted that, the diffractive element having wavelength-selectivity may be present at a midstream location of the rod integrator. Furthermore, the diffractive element having wavelength-selectivity may be present in the light incident side of the lens 35 or in the light incident side of the display panel.

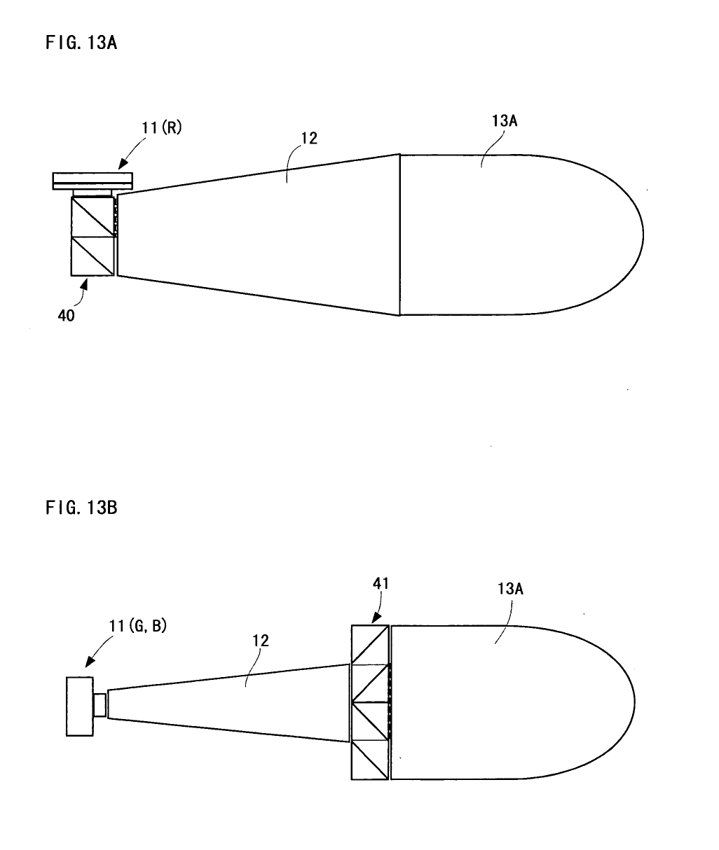

In the above described multi-color illuminating device and projection type video display, for example, a polarization conversion device 40 or a polarization conversion device 41 may be provided, as shown in FIG. 13A and FIG. 13B. The polarization conversion device 40 converts light incident from its side surface to S-polarized light. The polarization conversion device 40 has a structure which disposes two polarization beam splitters or a structure which disposes one polarization beam splitter and a reflecting member for reflecting light from the aforementioned polarization beam splitter. Then, a retardation plate (½λ plate) is provided either on a light emission side of one polarization beam splitter or on the light emission side of the reflecting member and a polarization direction is aligned by converting one polarized light to the other polarized light. As a matter of course, light can be converted to P-polarized light. It should be noted that, there may be adopted a structure in which the retardation plate is arranged between two polarization beam splitters or between one polarization beam splitter and the reflecting member. Furthermore, the polarization conversion device 41 has a dielectric multi-layered film (polarized light separating surface) in V-shaped at a position facing the light emission surface of the rod integrator 12. S-polarized light reflected on one surface of the dielectric multi-layered film is reflected by an adjacent reflecting member thereof (or the dielectric multi-layered film); similarly, S-polarized light reflected on the other surface of the dielectric multi-layered film is reflected by an adjacent reflecting member thereof (or the dielectric multi-layered film). P-polarized light which has passed through the dielectric multi-layered film is converted to S-polarized light by the retardation plate (½λ plate). As a matter of course, light can be converted to P-polarized light.

In this case, the illuminating device shown in FIG. 13A may be used as an illuminating device for a red color; and the illuminating device shown in FIG. 13B may be used as an illuminating device for a green color and an illuminating device for a blue color. The whole configuration as a projection type video display is the same as the projection type video display 4A. In such a configuration, a taper angle of the taper type rod integrator in the illuminating device for a red color is larger than taper angles of the taper type rod integrators in the illuminating device for a green color and the illuminating device for a blue color, as in the configuration shown in FIG. 3A and FIG. 3B. As a matter of course, it may be configured that the illuminating device for a green color and the illuminating device for a blue color include the polarization conversion device 41 and the illuminating device for a red color does not include the polarization conversion device 40.

Furthermore, as shown in FIG. 14, an optical filter with divergence angle dependent property may be provided in the illuminating device for a red color. That is, the illuminating device for a red color is provided with the optical filter, in which the larger a divergence angle of light is, the lower transmittance become. Thereby, divergence angle distribution of the light emitted from the illuminating device for a red color can be the same as that of the other illuminating devices. The aforementioned optical filter is made of a dielectric film, for example. Furthermore, it is preferable to dispose the optical filter at a place where, after the divergence angle of the light is reduced on the optical path in the illuminating device for a red color, that is, the optical filter may be disposed on the light incident side of the display panel or on the light incident side of the polarization beam splitter.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A multi-color illuminating device, comprising a plurality of illuminating devices for a plurality of lights in different colors, each of said plurality of illuminating devices including a solid light-emitting element for emitting color light and a light guide member for guiding the color light from said solid light-emitting element to an object to be illuminated,
wherein optical characteristics in one of said illuminating devices or in some of said illuminating devices differentiate from optical characteristics in other illuminating devices so that at least one of illuminance distribution, divergence angle distribution, and divergence angle distribution within surface in each light in respective colors guided to said object to be illuminated is approximated among each of said illuminating devices.

2. The multi-color illuminating device according to claim 1, wherein said illuminating device which is differentiated from said other illuminating devices includes a lens member disposed at any place between said solid light-emitting element and said object to be illuminated, for reducing a divergence angle of the light emitted from said solid light-emitting element.

3. The multi-color illuminating device according to claim 1, wherein each of said illuminating devices includes a taper type rod integrator in which a light emission surface is larger than a light incident surface as said light guide member; and
said rod integrator of said illuminating device which is differentiated from said other illuminating devices has a larger taper angle than that of said rod integrators of said other illuminating devices.

4. The multi-color illuminating device according to claim 1, wherein each of said illuminating devices includes a taper type rod integrator in which a light emission surface is larger than a light incident surface as said light guide member; and
said rod integrator of said illuminating device which is differentiated from said other illuminating devices has the same light incident surface and light emission surface as those of said rod integrator of said other illuminating devices, and at the same time is longer in length than that of said rod integrator of said other illuminating devices.

5. The multi-color illuminating device according to claim 1, wherein each of said illuminating devices includes a taper type rod integrator in which a light emission surface is larger than a light incident surface as said light guide member; and
said rod integrator of said illuminating device which is differentiated from said other illuminating devices has a curved surface reflecting region which is more convex than an inclined reflecting surface in other taper type rod integrator.

6. The multi-color illuminating device according to claim 1, wherein said illuminating device which is differentiated from said other illuminating devices has a lens-shaped portion in which said light guide member serves as a light condensing function or has a lens-shaped portion whose curvature is different from that of a lens-shaped portion in which other light guide member has.

7. The multi-color illuminating device according to claim 1, wherein each of said illuminating devices includes a rod integrator made of a transparent body as said light guide member; and
said illuminating device which is differentiated from said other illuminating devices has a rod integrator with a refraction index which is smaller than that of a rod integrator of said other illuminating device.

8. The multi-color illuminating device according to claim 1, wherein each of said illuminating devices includes a taper type rod integrator in which a light emission surface is larger than a light incident surface as said light guide member and a cuboid shaped rod integrator provided on a light emission side of said light guide member; and
length of said cuboid shaped rod integrator of said illuminating device which is differentiated from said other illuminating devices is different from that of said cuboid shaped rod integrator of said other illuminating devices.

9. The multi-color illuminating device according to claim 3, further comprising a cuboid shaped rod integrator on a light emission side of each of said taper type rod integrators; and
length of said cuboid shaped rod integrator in said illuminating device which is differentiated from said other illuminating devices is different from that of said cuboid shaped rod integrator in said other illuminating devices.

10. A multi-color illuminating device, comprising solid light-emitting elements for emitting color lights; an optical element for guiding color lights from said each solid light-emitting element to a specified direction depending on wavelength; and a taper type rod integrator as a light guide member for guiding the light emitted from said optical element to an object to be illuminated,
wherein said taper type rod integrator is formed with a tapered pipe-shaped surface functioning as a dichroic mirror surface with respect to a specified color light; and
said tapered pipe-shaped surface has an inlet port which is formed smaller than a light incident surface of said taper type rod integrator, whereby divergence angle distribution in each light in respective colors guided to said object to be illuminated is approximated among each light in respective colors.

11. A multi-color illuminating device, comprising solid light-emitting elements for emitting color lights; an optical element for guiding color lights from said each solid light-emitting element to a specified direction depending on wavelength; and a light guide member for guiding the light emitted from said optical element to an object to be illuminated, said multi-color illuminating device comprising:
a diffractive element having wavelength-selectivity disposed at any place between said solid light-emitting element and said object to be illuminated, for reducing a divergence angle with respect to a specified color light so that divergence angle distribution in each light in respective colors guided to said object to be illuminated is approximated among each light in respective colors.

12. A projection type video display, comprising a multi-color illuminating device as claimed in claim 1, said multi-color illuminating device including at least an illuminating device for a red color, an illuminating device for a green color, and an illuminating device for a blue color, said projection type video display comprising:
light valves for modulating each light in respective colors;
an optical element for generating color image light by guiding to a specified direction each modulated light passed through said each light valve; and
a projecting device for projecting said color image light.

13. A projection type video display, comprising a multi-color illuminating device as claimed in claim 10, said multi-color illuminating device including at least an illuminating device for a red color, an illuminating device for a green color, and an illuminating device for a blue color, said projection type video display comprising:
a single light valve provided on a light emission side of said light guide member; and
a projecting device for projecting color image light obtained by said single light valve.

14. The projection type video display according to claim 13, wherein said each light in respective colors is emitted in time-sharing manner; and
said light valve is driven by each video signal in respective colors depending on said time-shared timing.

15. The projection type video display according to claim 13, wherein said each light in respective colors is continuously emitted; and
said light valve includes a color filter.
